(19) United States
(12) Patent Application Publication
(10) Pub. No.: US 2020/0129842 A1
(43) Pub. Date: Apr. 30, 2020

(54) Skateboard Top With Integral Anti-Chipping / Anti-Delamination Reinforcement Layers

(71) Applicant: NHS, INC., Santa Cruz, CA (US)

(72) Inventors: Timothy Charles Piumarta, Aptos, CA (US); Benjamin Woody, Santa Cruz, CA (US); Jeffrey Kendall, Santa Cruz, CA (US)

(21) Appl. No.: 16/281,526

(22) Filed: Feb. 21, 2019

(30) Foreign Application Priority Data
Oct. 31, 2018 (CN) 201811284917.3

(51) Int. Cl. A63C 17/01; B32B 21/04; B32B 21/10; B32B 21/08; B32B 21/14; B32B 7/12

(52) U.S. Cl. CPC A63C 17/01; B32B 21/042; B32B 21/10; B32B 21/08; B32B 2260/046; B32B 7/12; B32B 2262/0269; B32B 2262/0276; B32B 21/14

(57) ABSTRACT

A skateboard top includes a laminate structure of a plurality of adhesive and press bonded wood veneers, with specified sections of some of the wood veneer layers removed and replaced with non-wood reinforcement layers integrated within the structure at both ends to increase durability through the prevention of wear and tear and impact related chipping and delamination. The usable life span of a typical skateboard comprising a plurality of wood veneer layers adhesively bonded into a single laminate structure is shortened by the impact chipping and following delamination of the skateboard which occurs during regular use. The disclosure discloses that by removing certain layers of wood and replacing with non-wood fiber reinforced layers comprised of a matrix of thermoset resin and multi-layer multi axial fiber reinforcements of glass or carbon or Kevlar, impact chipping is reduced and the durability and useable life span is increased.

### CROSS-REFERENCE TO RELATED APPLICATION

This application claims priority to Chinese Patent Application No. 201811284917.3, filed on Oct. 31, 2018, which is hereby incorporated by reference in its entirety.

### TECHNICAL FIELD

The present disclosure pertains to a skateboard, in particular the top component of the skateboard where the user stands.

### BACKGROUND

Skateboards have become common sporting goods and have been commercially produced since the 1950's in many forms. The skateboard comprises a platform upon which the user stands, called the skateboard top, and the two assemblies affixed to the bottom surface of the skateboard top, which are called the trucks. The trucks are steering devices and also provide for affixing the wheel/bearing units.

Skateboard tops must be strong and stiff in a multitude of directions, so when the user completes the skateboard assembly with the required 2 aluminum and steel steering devices called “Trucks”, which comprise the truck device itself, plus 8 steel “bearings” and 4 rubber or polyurethane “Wheels”, and the 8 steel machine screw and nut mounting fasteners, and finally a friction enhancing Grip Tape applied to the upper major surface of the top layer of the skateboard. The user may ride the skateboard along the ground, or off of objects and land with great force. In the regular course of product usage, the user will fall from the skateboard. The board and rider parting ways, and the skateboard may continue rolling along until it stops with an impact on a hard surface such as a wall, street curb, or the hard surface of the street or sidewalk.

The oldest iteration and most common structural form for the skateboard “top”—the surface upon which the user places his feet to stand upon, and steer the direction of the board, is a platform comprising a plurality of hardwood rotary cut veneer layers adhesively bonded into a single laminate structure. Manufacturing the skateboard top is done when a plurality of wood veneer layers are bonded and formed into single structure using pressure between 2 curved mold surfaces in a hydraulic press. The bonding of the wood veneers into a single structure is facilitated through the application of an adhesive upon the inner contact surfaces of each ply, using such adhesives as polyvinyl adhesives, urea adhesives, or epoxy adhesives. The Skateboard top after lamination is a single rectangular body which may be flat or have 3-dimensional bends or curves created in the pressing process and made up of a plurality of bonded rectangular hardwood veneers. After cure of the adhesive is complete, and removal from the forming hydraulic press molds, the final shape is cut from the single rectangular structure comprising the bonded layers. The edges may be sanded to make smooth and round, mounting holes drilled through the layers to affix the two truck, a wood sealing paint is applied to the surface, and the trucks and wheels assemblies are then affixed onto the bottom surface of the skateboard top, located near to the ends of the skateboard along the major axis, to facilitate rolling and steering, thus completing the assembly of the common skateboard.

Skateboard Tops need to be strong and light to allow the user to stand upon and apply force to either side of the board in order to transfer force to the steering devices called “trucks”. The skateboard top must be light to allow the user to easily steer, control and change direction of the skateboard assembly. To achieve enough strength to allow the user to stand on the skateboard top and not break it, but also be thin and light enough in weight to control the board while turning, changing direction, or performing stunts wherein the user will kick and flip the entire skateboard into the air and try to land on it, is the engineering balance which is most desired. To control the direction of the skateboard assembly when in use, the user must apply force with pressure on the feet to one side or the other of the centerline, or major axis, of the board. To effectively and efficiently transfer this force to the skateboard trucks, the skateboard top must have sufficient torsional strength to resist twisting along its major axis and thus absorbing some of the turning force. Torsional stiffness is important to the user providing a consistent and expected amount of force transmitted through the board into the trucks which is necessary to turn and control the board.

Wood, and in particular hardwoods, may be described as an orthotropic material, it has unique and independent mechanical properties in the directions of three mutually perpendicular axes: Longitudinal, radial and tangential. The longitudinal axis is parallel to the grain of the wood; the radial axis is normal to the growth rings of the tree (perpendicular to the grain the radial direction); and the tangential axis is perpendicular to the grain but tangent to the tree's growth rings (FIG. 14 of drawings). Measured mechanical properties, as provided by the Forest Products Laboratory Wood Handbook (Chapter 4, Mechanical properties of wood), recorded testing results demonstrate that the compressive strength of the species Acer Saccharum—Sugar Maple-in the Longitudinal Axis is 27,000 Kpa yet the compressive strength in the Tangential Axis is only 4400 Kpa. To prevent the skateboard from flexing and breaking, the commonly known in the art manufacturing practice of orientating the naturally occurring longitudinal grain direction of each wood veneer ply at prescribed angles to the others in the press bonding step is used. Orientating the longitudinal grain direction of a certain amount of the veneers perpendicular to each other creates a laminate which is strong and resistant to flexing and breakage in at least 2 directions. This orientation of veneer grain direction is also integral to creating torsional strength and stiffness.

A skateboard top “shape” which has been cut from this pressed and bonded multi ply wood grain oriented veneer structure, exhibits stiffness and strength longitudinally parallel to the major axis, and stiffness and strength perpendicular to the major axis, and stiffness and strength in torsion in a twisting direction along the major axis.

Skateboard top construction using a plurality of hardwood veneers is known in the art. This construction technique began in the United States of America in 1970's. Little has changed in the design from inception to present day. From inception to present day, variants of the laminated hardwood concept have been used, including but not limited to more and thinner plies of hardwood veneers, and improvements in adhesives which created stronger boards and more durable bonds between the veneer plies.

A common design known in the art is to use 7 plies of a hardwood veneer, and utilize a balanced veneer orientation described as:
the uppermost top layer of the skateboard top, with the longitudinal axis of the wood veneer grain running parallel to the longitudinal (major) axis of the skateboard top, then affixed to the bottom major surface of this ply is wood veneer ply #2;
wood veneer ply #2 with the longitudinal axis of the wood veneer grain running parallel to the longitudinal (major) axis of the skateboard top, then affixed to the bottom surface of the #2 ply is wood veneer ply #3;
wood veneer ply #3 with the grain direction running perpendicular to the longitudinal (major) axis of the skateboard top. Affixed to the bottom surface of #3 ply is wood veneer ply #4;
wood veneer ply #4 with the longitudinal axis of the wood veneer grain running parallel to the longitudinal (major) axis of the skateboard top, This #4 ply is also known as the center” ply, and it resides along the central or neutral axis of the skateboard top, directly between the top surface and the bottom surface ply. Affixed to the bottom surface of the #4 ply is wood veneer ply #5;
wood veneer ply #5 with the longitudinal axis of the wood veneer grain direction running perpendicular to the longitudinal (major) axis of the skateboard top. Affixed to the bottom surface of the #5 ply is wood veneer ply #6;
wood veneer ply #6 with the longitudinal axis of the wood veneer grain running parallel to the longitudinal (major) axis of the skateboard top. Affixed to the bottom surface of the #6 ply is wood veneer ply #7;
wood veneer ply #7 with the longitudinal axis of the wood veneer grain running parallel to the longitudinal (major) axis of the skateboard top. In the common 7 ply hardwood veneer skateboard, the bottom major surface of this #7 ply can be considered the bottom major surface of the skateboard top.

While a multitude of common skateboard tops use this 7 ply bi axially oriented construction, there are other constructions utilizing more plies and those plies can also be orientated in either parallel or perpendicular to the major axis. It is not uncommon to see skateboard tops made using 8 plies, 9 plies, 10 plies. Each of these examples will have a unique and particular set of layers oriented in either a parallel or perpendicular direction, yet all will exhibit a balance of veneer layer orientations which are mirrored about the Neutral Axis center ply.

The compressive strength, and resistance to flex in wood, and in particular the veneers used to make up a skateboard, is greater in the direction parallel to grain than it is perpendicular to grain. The strength of a veneer in resistance to tensile force is also greater in the direction parallel to the grain then it is perpendicular to the grain. The strength of a veneer in resistance to compression force is also greater in the direction parallel to the grain then it is perpendicular to the grain. Also, the strength of a veneer in resistance to shearing force is greater in the direction parallel to the grain then it is perpendicular to the grain.

When veneer is in the described orientation with layers 1, 2, 4, 6 and 7 with grain parallel to the major axis of the skateboard top and layers 3 and 5 with grain perpendicular to the major axis, layers 3 and 5 are subjected to more compressive or tensile forces perpendicular to their grain direction during common use and impacts with the ground and or other objects at the ends of the skateboard top where the impacts may occur most. Layers 3 and 5 are oriented in such a direction as to make them weaker in tensile and compressive forces under impact stress then the adjacent plies which have orientation of grain parallel to the major axis of the board. This is the problem in which the disclosure teaches to solve.

Tensile forces acting simultaneously on all 7 layers of the structure can be described as flexing, and also abrasive wear when the bottom layers at the end of the skateboard's major axis come into contact with the ground.

Compressive forces acting simultaneously on all 7 layers of the structure can be described as the impact of the ends of the skateboard against solid objects, for example a wall, a curb or the ground itself. These forces are commonplace to the use of the skateboard, as the user will ride the skateboard and occasionally jump off or fall off while riding or performing stunts or tricks. The impact areas are at the ends of the major axis, commonly known as the ends of the skateboard top. Impact forces are derived from the contact of the edges of the skateboard top with solid objects. These impacts impart a compressive force to the edge of the laminated skateboard top structure. As noted by the compressive strength characteristics of wood veneers in parallel to or perpendicular to the wood grain orientation, 5 of the plies which are parallel to the impact force direction resist compression and dissipate the force along the longitudinal direction of the grain. 2 of the plies of the wood veneer which are oriented with the longitudinal grain direction perpendicular to the impact force will crush, compress, and break. Upon compression and breaking from repeated impacts, the 5 plies of the wood veneer which are oriented parallel to the impact force can become separated from the 2 plies oriented perpendicular to the impact force, the interface bond between the #2 and #3 and #4 plies, and or the #4 and #5 and #6 plies may be broken, and some layers may break off the skateboard top structure, leaving the skateboard top badly damaged and un-usable.

The #3 and #5 plies in a common 7 ply skateboard top are subject to early failure through the compressive forces inherent in the use of the product through falls and the resulting impacts.

The disclosure differs from other fiber reinforcement skateboards described in patents such as Gallo (U.S. Pat. No. 7,735,844 B2). In Gallo, Thin fibers are bonded to the surfaces of the plies and not direct replacement or substitution of the wood ply in its entirety. In Gallo, wood veneers with grain direction orientated perpendicular to the major axis of the skateboard are still exposed to impacts and exposed to the compressive forces which cause these veneers to break. Bonding a reinforcement to the top and bottom major surfaces of the veneers still leave the veneer itself exposed to forces.

This new skateboard top disclosure is unique by not bonding reinforcement to the major surfaces of the veneers but to replace the veneer completely. Gallo does not do this, and as such the impacts on the edges of the Gallo skateboard still allow the veneers to compress, and chip.

### SUMMARY

According to one aspect of the disclosure, a skateboard top comprising a plurality of layers of hardwood veneer layers is provided.

The skateboard top as above, wherein the layers have a natural wood grain orientation running either parallel or perpendicular to the major axis of the skateboard top.

The skateboard top as above, wherein 5 of the layers have grain orientation running parallel to the major axis and 2 of the layers have grain orientation running perpendicular to the major axis of the skateboard top.

The skateboard top as above, wherein the 2 layers with grain running perpendicular to the major axis of the skateboard top have been modified with an omni directional strength material placed at both ends of the major axis of the skateboard top.

The skateboard top as above, wherein the omni directional strength material is comprised of a non-wood material.

The skateboard top as above, wherein the omni directional strength material may be a stitched or woven layer of fibers saturated with an adhesive.

The skateboard top as above, wherein the adhesive may be comprised of a thermoset epoxy.

The skateboard top as above, wherein the adhesive may be comprised of a thermoset polyurethane.

The skateboard top as above, wherein the omni directional strength material may be comprised of fiberglass.

The skateboard top as above, wherein the omni directional strength material may be comprised of nylons, aramids or polyester engineering thermoplastics.

The skateboard top as above, wherein the omni directional strength material may be comprised of a solid engineering thermoplastic sheet.

The skateboard top as above, wherein the omni directional strength material is equal in thickness dimension to the adjacent veneer.

The skateboard top as above, wherein the adhesive may be comprised of a thermoset epoxy.

The skateboard top as above, wherein the adhesive may be comprised of a thermoset polyurethane.

According to another aspect of the disclosure, a skateboard comprising the skateboard top as above is provided.

### BRIEF DESCRIPTION OF THE DRAWINGS

FIG. 1: Isometric view of the skateboard top assembled with trucks—steering devices, and the wheels and components required to affix the wheels to the trucks and the trucks to the bottom major surface of the skateboard top.

1a is the upper surface of the skateboard top, where the user places his or her feed to stand and control the direction of the skateboard.

1b: indicates with a dotted line the major axis of the skateboard top. 1c: indicates with a dotted line the minor axis of the skateboard top.

FIG. 2: is an angled isometric view of the skateboard top assembled with the trucks and wheels.

2a: indicates the mounting nuts and bolts for affixing the trucks and wheels to the bottom major surface of the skateboard top.

FIG. 3: Isometric view of the skateboard top and it's bottom major surface 3a, with trucks (2x) 3d mounted along the major axis 3b. Minor axis of the skateboard top is noted at 3c

FIG. 4: side view of assembled skateboard top and trucks and wheels, 4a indicates the location of the formed ends of the skateboard top.

FIGS. 5-9 illustrate some but not all components of hardwood veneers which are used to make the multiple layered skateboard top.

FIG. 5: end view of the assembled skateboard top and trucks and wheels, 5a indicating the area near the end of the skateboard's major axis where impacts are common, and also the zone where the disclosure's omni directional reinforcement is located.

FIG. 6: top view of one of the hardwood veneer plies which comprise layers 1,2,4,6,7. 6a indicates the overall shape of the skateboard top veneer, and 6b indicates the natural wood grain direction running parallel to the major axis of the skateboard top.

FIG. 7: top view of one of the hardwood veneer plies which comprise layers 3 and 5. 7a indicates the overall shape of the skateboard top veneer, and 7b indicates the natural wood grain direction running parallel to the minor axis of the skateboard top. FIG. 7 is a layer which is integral to common skateboards, and is one which the disclosure modifies as shown in in FIG. 8

FIG. 8: top view of the hardwood veneer noted in FIG. 7, with ends removed at 8a (both ends). 8b indicates the overall shape of the skateboard top veneer.

FIG. 9: Top view of the hardwood veneer noted in FIG. 8, with Omni Directional Strength Material placed at both ends indicated at 9a. 9b indicates the overall shape of the skateboard top veneer.

FIG. 10: The order of layering of the veneers after application of the adhesive, but before placement into the hydraulic press.
10a is the top layer of the hardwood veneer, with natural wood grain direction running parallel to the major axis of the skateboard top
10b is the next layer of the hardwood veneer, with natural wood grain direction running parallel to the major axis of the skateboard top
10c is the next layer of the hardwood veneer, and is the modified hardwood veneer, with the omni directional material located at both ends of the major axis, and the natural wood grain of the hardwood veneer running parallel to the minor axis of the skateboard top
10d is the next layer of the hardwood veneer, with natural wood grain direction running parallel to the major axis of the skateboard top
10e is the next layer of the hardwood veneer, and is the modified hardwood veneer, with the omni directional material located at both ends of the major axis, and the natural wood grain of the hardwood veneer running parallel to the minor axis of the skateboard top
10f is the next layer of the hardwood veneer, with natural wood grain direction running parallel to the major axis of the skateboard top
10g is the bottom layer of the hardwood veneer, with natural wood grain direction running parallel to the major axis of the skateboard top

FIG. 11: This isometric view is of the orientation of veneers, which the pressed shape of the skateboard indicated by the raised ends. This view is to teach the location of the modified veneers 11c and 11e within the location of all hardwood veneer plies.
11a is the top layer of the hardwood veneer, with natural wood grain direction running parallel to the major axis of the skateboard top
11b is the next layer of the hardwood veneer, with natural wood grain direction running parallel to the major axis of the skateboard top
11c is the next layer of the hardwood veneer, and is the modified hardwood veneer, with the omni directional material located at both ends of the major axis, and the natural wood grain of the hardwood veneer running parallel to the minor axis of the skateboard top
11d is the next layer of the hardwood veneer, with natural wood grain direction running parallel to the major axis of the skateboard top
11e is the next layer of the hardwood veneer, and is the modified hardwood veneer, with the omni directional material located at both ends of the major axis, and the natural wood grain of the hardwood veneer running parallel to the minor axis of the skateboard top
11f is the next layer of the hardwood veneer, with natural wood grain direction running parallel to the major axis of the skateboard top
11g is the bottom layer of the hardwood veneer, with natural wood grain direction running parallel to the major axis of the skateboard top

FIG. 12 is an isometric view of the skateboard top with the trucks and wheels affixed.
12a and 12b indicate the area which the reinforced omni directional strength material is embedded within the shape of the skateboard top, at both of the ends of the major axis.

FIG. 13 is an enlarged isometric view of one of the ends of the skateboard top of FIG. 12, at area 12a.
13a and 13b indicate the presence of the disclosure's omni directional strength material embedded in the pressed hardwood veneer skateboard top, visible from the edge of the laminate structure 13c.

FIG. 14 is an isometric view of an example of a piece of hardwood veneer, indicating the 3 axes of grain fiber direction (14d), including radial (14a), longitudinal (14b) and tangential (14c).

### DETAILED DESCRIPTION

In illustration of the terminology used in the preferred embodiments of the disclosure, FIG. 14 of the drawings teaches the 3 axes of fiber grain direction in wood, with the grain indicated at (14d), and the radial axis of wood at (14a), and the longitudinal axis of wood at (14b), and finally the tangential axis of wood at (14c).

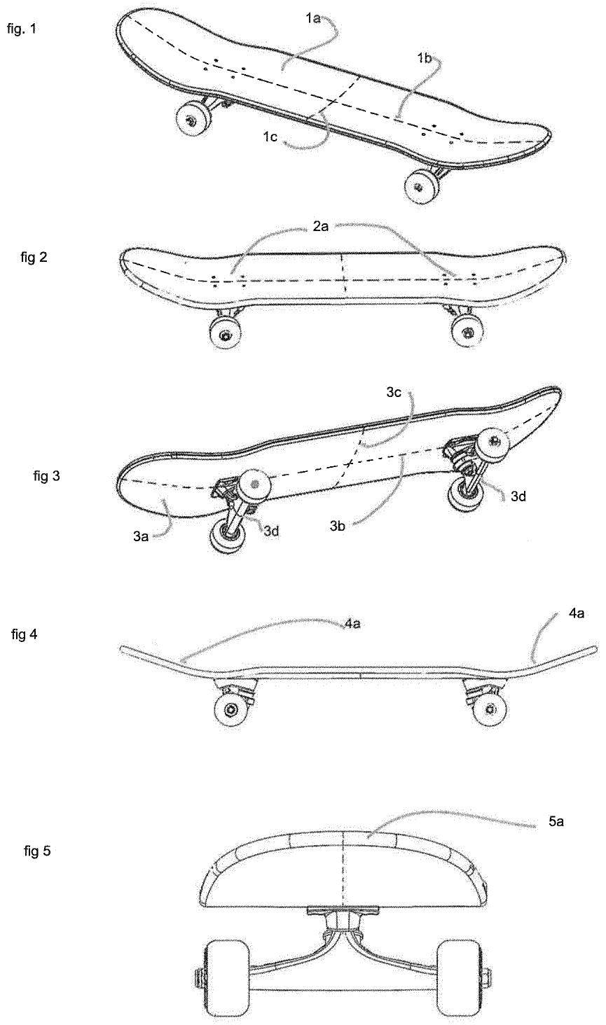

Referring to the figures of the embodiment now, FIG. 3 describes the disclosure of the skateboard top as it is assembled with the trucks and wheels (3d) onto the bottom major surface of the skateboard top (3a). The trucks and wheels are shown affixed to the skateboard top in FIG. 2, by 8 machine screws and nuts mounted through drilled holes in skateboard top at (2a). It is important now to note the skateboard top axes in FIG. 1, with the major axis (1b) running between the two ends, and the minor axis (1c) running from side to side or perpendicular to the major axis (1b).

The preferred embodiment of this disclosure of a skateboard top with integral anti-chipping/anti-delamination reinforcement layers comprising non grain omni-directional strength materials has three dimensional curved surfaces pressed into the skateboard top as FIG. 4 indicates in side view. At both ends of the longitudinal axis a portion the skateboard top is bent up (4a), away from the major bottom surface of the skateboard top FIG. 3 (3a). The disclosure is located within this portion of the skateboard top, and in part is exposed to the edge of the skateboard at both ends. FIG. 5 (5a) shows and end view of the assembled skateboard and top, with the area noted at (5a) as a common impact and damage area.

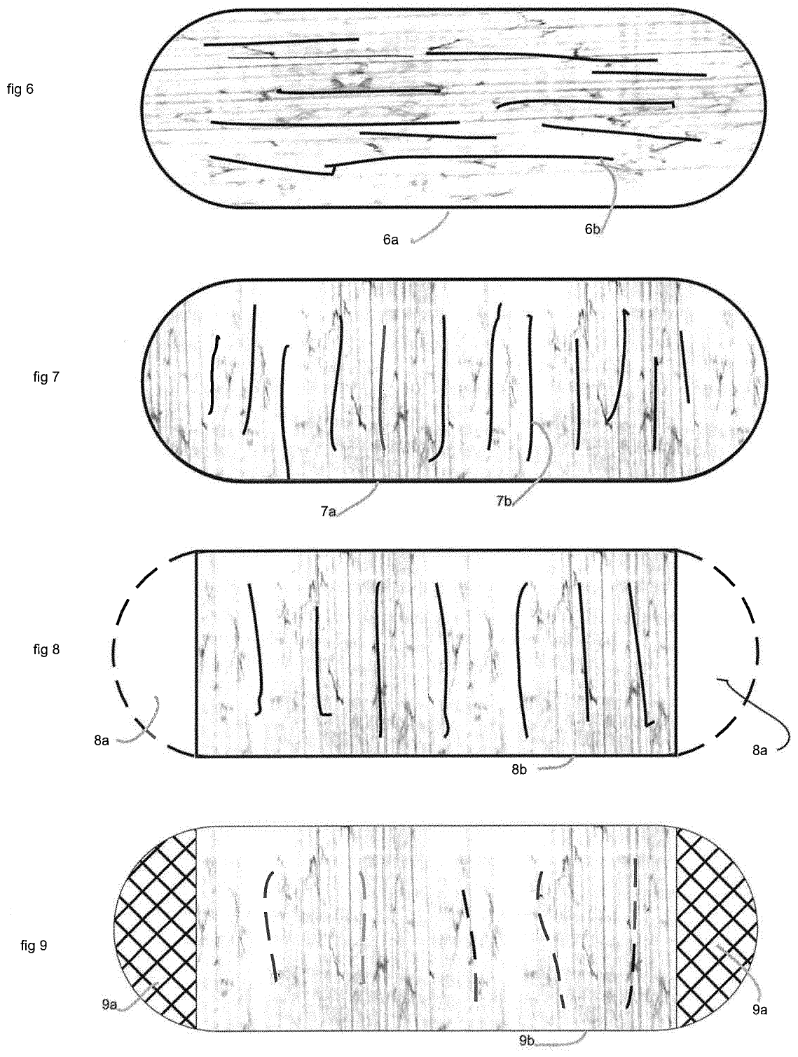

The disclosure can be illustrated best by separating each individual component layers shown in FIG. 6 and FIG. 7, comprising the laminated hardwood veneer layers in the different grain orientations. Looking to FIG. 6, this is a layer cut to the desired shape of the skateboard top (6a) and hardwood veneer wherein the natural grain direction of the wood (6b) is oriented parallel to the major axis of the skateboard top. FIG. 7 shows a layer cut to the desired shape of the skateboard top (7a) and hardwood veneer wherein the natural grain direction of the wood (7b) is oriented perpendicular to the major axis of the skateboard top.

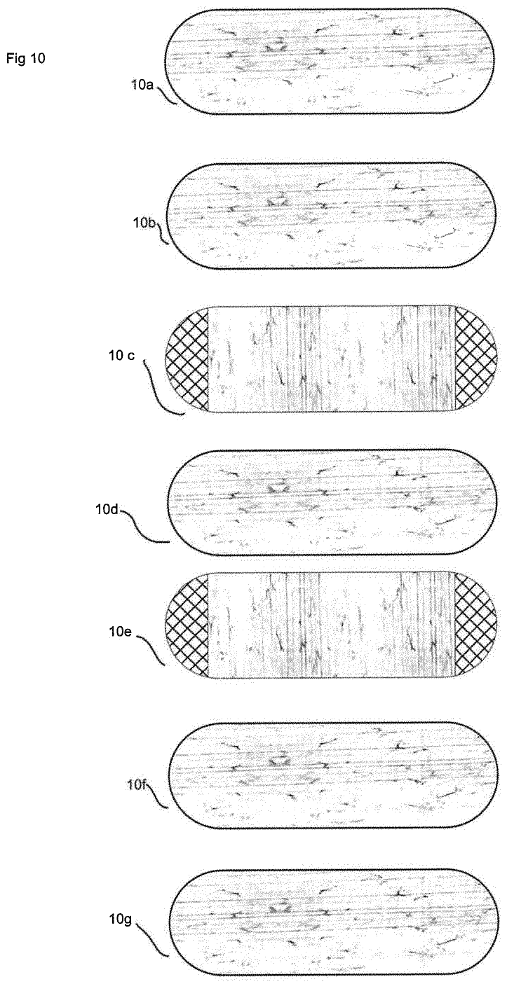

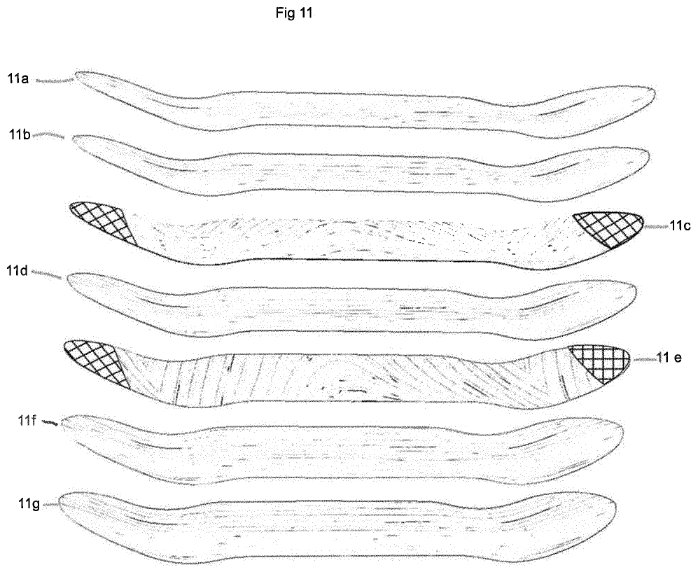

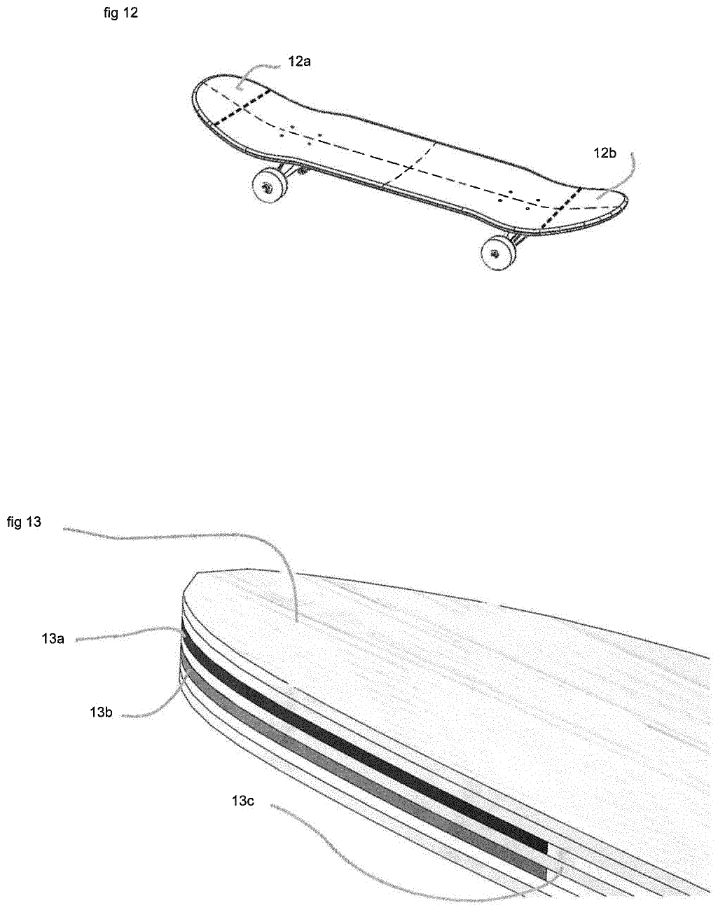

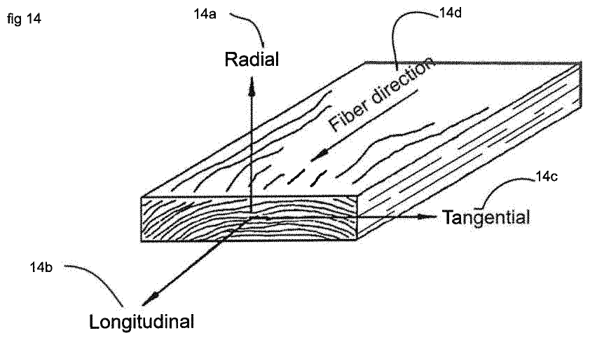

FIG. 8 and FIG. 9 show the method of placing the disclosure of integral anti-chipping/anti-delamination reinforcement layers comprising non-grain omni-directional strength material into the layer indicated in FIG. 7. Portions of the ends of the hardwood veneer layer are removed as shown in FIG. 8 at (8a). In FIG. 9, the non-grain omni-directional strength material (9a) is inserted and affixed to the wood veneer (7b). The material is then cut to the shape of the skateboard top (9b).

Now that we have described 2 of the 7 layers comprising the disclosure of the skateboard top, FIG. 10 shows the order of the total layers of the skateboard top, using multiple layers as described in FIG. 6 and FIG. 9. The top layer hardwood veneer (10a) will have affixed to it layer (10b), then layer (10c) with it's portions of integral anti-chipping/anti-delamination reinforcement layers comprising non grain omni-directional strength material, then layer (10d), and affixed to that is layer (10e) also with it's integral anti-chipping/anti-delamination reinforcement layers comprising non grain omni-directional strength material, then affixed to that is layer (100, and affixed to that is layer (10G) which comprises the bottom major surface for the skateboard top.

The layers are affixed and bonded into a 3 dimensional shape shown in exploded side view of FIG. 11, showing the portions of the skateboard top layers which are bent upwards away from the bottom major surface of the skateboard top as indicated at (11a), (11b), (11c), (11d), (11e), (11f), (11g).

After the individual wood layers are bonded together using adhesives and press molded to shape into a single structure as shown in FIG. 12, position of the integral anti-chipping/anti-delamination reinforcement layers comprising non grain omni-directional strength material is shown at position (12a) and (12b) in hidden view as indicated by the dotted lines.

A close-up view is helpful to see the detailed layering of all the veneers, including the veneers of the disclosure which include the integral anti-chipping/anti-delamination reinforcement layers comprising non grain omni-directional strength material. FIG. 13 shows an end portion of the skateboard top bonded and laminated veneer structure. The visible layers of integral anti-chipping/anti-delamination reinforcement layers comprising non-grain omni-directional strength material are shown at (13a) and 13b.

The disclosure teaches to replace sections of the #3 and #5 wood veneer plies in said common 7 ply skateboard top with a non-grain, omni directional strength material, and in particular replacement in the portions of the 7 ply skateboard top directly adjacent to the impact areas at the ends of the major axis.

Replacement of the ends of the #3 and #5 wood layers with the omni-directional strength material is performed before the layers are laminated together. Wood layers #3 and #5 are modified to make shorter than the adjacent plies, and pieces of the omni directional strength material are set in place as the individual veneers have the adhesive applied and the stack of 7 total plies is assembled prior to placement in the hydraulic forming press.

The problem of other skateboard constructions can be solved through the use of this disclosure. The problem of failure via chipping or delamination of wood layers through impacts can be reduced or eliminated, with the substitution of the omni directional strength material where the weaker #3 and #5 wood layers are subject to compressive impact forces at the ends of the skateboard top along the major axis. Because the strength of the omni-directional strength material is greater in compression than wood veneer, substitution of omni directional strength material in place of the wood veneer increases the durability, impact strength and lifespan of the skateboard top structure.

The preferred non grain, omni directional strength material can be, but not limited to, a single layer or multitude of layers of bi axial, tri axial or quad axial fiberglass cloth or weave, which is saturated with a resin matrix acting as an adhesive between the fiberglass fibers to themselves, and between the fiberglass layer and the adjacent major surfaces of the wood veneers. Other non-grain, omni directional strength materials can be a solid engineering thermoplastic sheet, or, woven or stitched layers of fabrics using non glass fibers such as nylons, aramids or polyester blends. The thickness dimension of the omni directional strength material must be the same as the wood layer material it replaces.

1. A skateboard top comprising a plurality of layers of hardwood veneer layers.

2. A skateboard top of claim 1, wherein the layers have a natural wood grain orientation running either parallel or perpendicular to the major axis of the skateboard top.

3. A skateboard top of claim 1, wherein 5 of the layers have grain orientation running parallel to the major axis and 2 of the layers have grain orientation running perpendicular to the major axis of the skateboard top.

4. A skateboard top of claim 3, wherein the 2 layers with grain running perpendicular to the major axis of the skateboard top have been modified with an omni directional strength material placed at both ends of the major axis of the skateboard top.

5. A skateboard top of claim 4, wherein the omni directional strength material is comprised of a non-wood material.

6. A skateboard top of claim 4, wherein the omni directional strength material may be a stitched or woven layer of fibers saturated with an adhesive.

7. A skateboard top of claim 4, wherein the adhesive may be comprised of a thermoset epoxy.

8. A skateboard top of claim 4, wherein the adhesive may be comprised of a thermoset polyurethane.

9. A skateboard top of claim 4, wherein the omni directional strength material may be comprised of fiberglass.

10. A skateboard top of claim 4, wherein the omni directional strength material may be comprised of nylons, aramids or polyester engineering thermoplastics.

11. A skateboard top of claim 4, wherein the omni directional strength material may be comprised of a solid engineering thermoplastic sheet.

12. A Skateboard top of claim 4, wherein the omni directional strength material is equal in thickness dimension to the adjacent veneer.

13. A skateboard top of claim 11, wherein the adhesive may be comprised of a thermoset epoxy.

14. A skateboard top of claim 11, wherein the adhesive may be comprised of a thermoset polyurethane.

15. A skateboard, comprising the skateboard top of claim 1.
